(19) United States
(12) Patent Application Publication
(10) Pub. No.: US 2012/0150563 A1
(43) Pub. Date: Jun. 14, 2012

(54) Prescription Verification System

(76) Inventors: Sean Carroll, Trent Woods, NC (US); Christopher Hoeler, Phoenix, AZ (US)

(21) Appl. No.: 13/315,805

(22) Filed: Dec. 9, 2011

Related U.S. Application Data
(63) Continuation-in-part of application No. 13/270,508, filed on Oct. 11, 2011.
(60) Provisional application No. 61/421,469, filed on Dec. 9, 2010.

(51) Int. Cl. G06Q 50/22

(52) U.S. Cl. 705/3; 705/2

(57) ABSTRACT

A prescription verification system and method is provided that stores and processes information on one or more servers for verifying medical prescription orders originating from healthcare providers. The system and method enables one or more clients to retrieve medical prescriptions and for ordering personnel information for prescription verification through the system. The system includes functionality for entering, editing, or deleting data files and retrieving and displaying them as requested by authorized users as they pertain to ordering, verifying, filling and tracking of medical prescriptions.

### CROSS-REFERENCE TO RELATED APPLICATIONS

This application is a continuation-in-part of U.S. patent application Ser. No. 13/270,508, filed Oct. 11, 2011, the application of which claims priority and is related to U.S. Provisional Patent Application Ser. No. 61/421,469, filed Dec. 9, 2010, the disclosures of which are incorporated by reference in their entirety.

### BACKGROUND OF THE INVENTION

1. Technical Field

The invention disclosed herein relates generally to a prescription verification system, a method for verifying medical prescription orders originating from authorized healthcare providers, and to providing systems and methods related thereto. More particularly, the system and method allows access by authorized users, or computers, to the prescription verification system for entry and retrieval of information for validating, verifying, and/or tracking medical prescription orders.

2. Background Art

In most current prescription environments, pharmacies require either a written prescription authorized by the signature of a licensed physician which is presented at the store counter, a telephone order with direct contact validation over the telephone from a licensed physician's office before a prescription can be filled, or an electronic transmission. In the event a prescription is called in through the phone to a pharmacy, the pharmacist has no means of easily verifying that the person placing the order is authorized to do so, or even if the prescription is authentic.

If a prescription is presented at the pharmacy counter without the originator's DEA, NPI or state license numbers, the pharmacist also has no simple way of verifying the information. The only validation protocol currently available is required contact by telephone for every order received. This results in a time consuming process and the pharmacy must contact the healthcare provider office during normal office hours. As such, this prevents validation of prescriptions at times other than normal business hours.

One attempted solution to the problems discussed is disclosed in U.S. Pat. No. 5,845,255 which relates to a prescription management system. A wirelessly deployable, electronic prescription creation system is provided for physicians use. The system captures into a prescription a patient condition-objective of the prescribed treatment, and provides for patient record assembly from source elements, with privacy controls for patient and doctor, adverse indication review and online access to comprehensive drug information. While such a system is useful from a patient management perspective, it fails to provide a secure verification system for use in communications between a healthcare provider and a pharmacy.

U.S. Patent Publication No. 2006/0064326 discloses a system and process for prescribing medications through the internet. The system includes a secured, interactive website for entering and retrieving medical prescriptions. The website is accessible via the internet at a unique URL address by a general use computer. Access by medical personnel may be limited by requiring an authorized identification code and by pharmaceutical personnel also being required to have an identification code. The pharmacies can be selected by the physician so that the physician can enter a prescription into the secured website of the medical prescription service. The pharmacy selected by the patient can access the medical prescription service website, located in the patient's record, obtain the prescription and fill the prescription. Such a system is a newer form of prescribing and a departure from what is now the more traditional process of calling in a prescription by medical personnel or presenting a written prescription to a specific pharmacy, and thus does not address the issue of verifying call in, written drop-off prescriptions, and/or electronic prescriptions.

As such, there remains a need for systems and methods which allow traditional call in of prescriptions, drop off of written prescriptions, and/or electronic prescribing to be implemented in a secure and verifiable manner.

### BRIEF SUMMARY OF THE INVENTION

According to one embodiment of the present invention, a prescription verification system is provided wherein the system includes one or more servers with a web interface for hosting a website and/or one or more database servers, wherein the servers are configured for managing information relating to medical personnel, electronic prescribing software, third party electronic prescription providers, pharmacies, and/or patients. A first portion of the system serves to create and allow access to created individual medical personnel files. A second portion of the system serves to create and allow access to created pharmacy files and a third portion of the system serves to create and allow access to created individual patient files or information (e.g., prescription data). The system is further configured for assigning and displaying unique identification codes, e.g., identification codes, for authorizing users of the system. The identification code may be uniquely assigned by the system or be created and/or edited by the authorized user. This allows, for example, verification of called in prescription information, for example, by the medical personnel providing an identification code, which verifies the authority to order the prescription, and which can be searched on the system by a pharmacy having access to the system through a computer, such as, a general purpose computer, or other suitable device, such as personal digital assistants (“PDAs”), portable telephones, tablets, smart phones, satellite or any other suitable access device, any combination of such devices, or any other device that is capable of communicating with the system website and/or database, such as through the internet or other suitable communication means, including but not limited to, intranet, a wide-area network (“WAN”), a local-area network (“LAN”), a wireless network, a digital subscriber line (“DSL”) network, a frame relay network, an asynchronous transfer mode (“ATM”) network, a virtual private network (“VPN”), or any combination of any of such networks. The system may include communications links, which may be any communications links suitable for communicating data, e.g., between servers and devices, such as network links, dial-up links, wireless links, hard-wired links, satellite links, any other suitable communications links, or a combination of such links.

In one embodiment, the communications with the system servers is secure and may include an encryption function and only individuals having an authorized code can access the system. Other features can be added to make the system more user friendly.

In another aspect there is provided a computer implemented method of verifying prescription information. The method involves providing a system with one or more servers with a web interface for hosting a website, such as a secured interactive website and/or one or more database servers configured for managing information relating to medical personnel, electronic prescribing software, electronic prescription providers, pharmacies and/or patient information, wherein the system may be a secured system, for example the system website and/or databases may be secure. Medical practices may be registered at the system, along with all medical practice staff authorized to call in prescriptions. During registration, a unique medical staff identification code is assigned for each medical staff member authorized to call in prescriptions. Similarly, pharmacies can be registered at the system, and may include pharmacist information. Call in prescriptions may be properly verified and filled by an authorized medical staff presenting their identification code, and verification by a pharmacy staff member, who verifies the prescription by accessing the system and entering the presented identification code into the system. Yet, still further, the system can have an image repository for allowing comparison of the prescription details as written (e.g., physician's signature, quantity, dosage, image of the prescription, and/or other information on the prescription), to the prescriptions presented to the pharmacy for verification purposes.

In a yet further aspect, there is provided a centralized system for verifying medical prescriptions, such as through the internet or other suitable communication methods. An interactive secure website and/or database server is provided on a server which is accessible through a computer or other suitable device, via a communications link, such as through the internet or other suitable communication method, for storing and retrieving medical provider information for use in verification of prescription orders. The system is configured for allowing access by pharmacy, medical personnel, and/or third party electronic prescription providers/software having authorization. The system is further configured for creating business accounts for pharmacies, medical personnel, and/or third party electronic prescription providers or software, and configured for editing the accounts by authorized personnel.

The system can be further programmed to allow entry of fraud incidents experienced by authorized personnel.

As may be appreciated in accordance with the systems and methods described herein, an easy, secure and effective method for pharmacy/medical provider partnership is provided that allows verification of medical prescriptions at any time worldwide, while reducing the manpower and time necessary to complete the verification. In an example, pharmacies and medical practices subscribe to the secured system as a way of implementing the system and method. Third parties, such as third party electronic prescription providers, may also sign up to the prescription verification system to provide prescription verification for electronically generated prescriptions.

Objects of the present invention having been stated herein above, and which are addressed in whole or in part by the present invention, and other objects will become evident as the description proceeds when taken in connection with the accompanying drawings as best described herein below.

### BRIEF DESCRIPTION OF THE DRAWINGS

FIG. 1 is a block diagram illustrating an example how a business account may be established with the system and method of the invention;

FIG. 2 is a block diagram illustrating an example how access to the system of the invention may be conducted by a pharmacy and/or by a medical practice;

FIG. 3 is a block diagram illustrating an example how administrators and clients may subscribe to the system, and allowed administrative level access to the system for modification of client information;

FIG. 4 is a block diagram illustrating an example how physicians, pharmacists, and staff users may be registered for allowing access to the system; and

FIG. 5 is a block diagram illustrating an example how a pharmacy staff user accesses and uses the system.

### DETAILED DESCRIPTION OF THE INVENTION

Prior to continuing with the detailed description of the invention, the following definitions are provided to facilitate an understanding of the system and method described herein.

WEBSITE means a connected group of pages on the World Wide Web, regarded as a single entity, usually maintained by one person or organization and devoted to a single topic or severally closely related topics.

WEBPAGE means a document on the World Wide Web consisting of an HTML, or other similar type code, file and any related files, and often hyperlinked through other documents on the World Wide Web. The content of web pages is normally accessed by using a web browser.

WEB BROWSER means a program that accesses and displaces files and other data available on the internet and/or other networks.

URL means an internet address usually consisting of the access protocol (“http”), the domain name, and optionally the path to a file or resource residing on that server.

INTERACTIVE means of or relating to a program that responds to user activity.

SERVER means a computer that controls a central depository of data that can be manipulated in some manner by a client, and may include a web interface for hosting a web site and/or one or more database servers.

ENCRYPTION means to alter information using a code or mathematic algorithm so as to be unintelligible to unauthorized readers.

FTP means a communication protocol governing the transfer of files from one computer to another over a network.

ISP means internet service provider, which is a business providing connection to the internet and other related services.

The system and method of the invention provides prescription verification and tracking of prescriptions worldwide at any time. The system and method of the invention also provides for prescription verification and tracking of all types of prescriptions, including but not limited to drugs, wheelchairs, oxygen, or any product or service requiring a prescription to be dispensed or carried out. The system and method of the invention further provides verification and tracking of prescriptions from more than one source, for example, verification and tracking of prescriptions generated from the system of the invention, third party electronic prescribing entities/software, hospitals, doctors offices, homecare services, nursing services, or any other sources of a prescription. Additionally, the system and method of the invention may be a stand alone verification system, or alternatively work in conjunction with an electronic prescribing system (for example a proprietary electronic prescribing system may be incorporated as part of the system).

By way of further explanation, a medical practice is one type of organization that may subscribe to the system and method of the invention. The medical practice registers the practice with the system and provides pertinent information about the practice and the associated primary healthcare providers (PHP), and registers all medical staff members authorized to order prescriptions. Each medical staff member authorized to order prescriptions is assigned a unique identification code by the system, or alternatively the authorized user may select their own unique identification code. The unique identification code may be made up of any combination of letters and/or numerical integers, e.g., a letter character prefix and a numerical integer, or other suitable identification code. The identification codes are unique to each individual authorized to order prescriptions by the medical practice, and are preferably not public knowledge and password protected.

When a medical staff member authorized to order prescriptions phones in a prescription order (prescription caller), they provide their identification code, and may also provide their name, healthcare provider's name they represent, and practice name. This information is used in the verification process on the pharmacy side for phone-in orders.

When originating a prescription, the healthcare provider may record the amount, type of medication, recipient/patient, refills, date, and/or an actual image of the prescription. For example, the healthcare provider may record the information to a database accessible by the prescription verification system (e.g., the healthcare provider may enter the prescription details and/or record an image of the prescription as written and upload it to the prescription verification system). The recorded prescription information may be accessible, via the prescription verification system, by a registered pharmacy's staff member (e.g., pharmacist or pharmacy technician) to validate the prescription details, and potentially expose prescription alterations. Written or computer-generated prescriptions may be printed, and may include a unique identifier, such as a barcode, QR code, symbol, alpha numeric code, or other suitable unique identifier. The written or computer-generated prescriptions may be printed, and may be printed/written on a tamper proof paper. Prescription details and/or an image of the prescription may be listed under the unique identifier and stored in a database for access by the pharmacy staff member by inputting the unique identifier into the system, for example the pharmacy staff member may scan in a barcode that is on a presented prescription.

To implement the subscription, information about the medical practice, primary healthcare provider information and license data needs to be entered into the system. This information can be updated as needed and pharmacies will have access to the information through the system instead of having to make direct phone contact, unless a discrepancy is detected, fraud is suspected, or information is not presented. This eliminates the need for phone contact to validate every medical prescription, thus saving time, valuable manpower, and providing validation of prescriptions at any time of day.

On the pharmacy side, each participating pharmacy registers the pharmacy and may include pharmacist information, and may include other pharmacy staff member information, e.g., pharmacy technicians. When a phoned-in prescription order is received, the registered pharmacy's staff member enters the stated identification code of the caller into the system, for example the pharmacy staff member may enter the caller's identification code into the system. If the identification code is valid, the prescription caller's name and matching identification code will preferably be displayed with the associated healthcare provider's information, which may include a practice name, address, phone number, primary healthcare providers and their DEA, NPI and state license numbers. The information may be compared to the data stated in the phone order, on a written/printed prescription, or indicated in an electronic prescription order, and authenticity can be verified. Once the prescription is filled the pharmacy can mark the prescription as filled, thus providing real time data to the healthcare providers and/or pharmacies as to which prescriptions are filled or unfilled. This provides the ability for accurate real time reporting. Further, when the prescription is filled and marked as filled, the system can give a confirmation code to the pharmacy staff member. The pharmacy can record the confirmation code on the prescription, and this will show that the prescription's authenticity has been confirmed and the pharmacy has used the prescription verification system before filling the prescription. When the prescription is marked as filled it also will indicate as such on the system should the prescription information be retrieved again. In the case where someone copies a prescription and takes it to the same or other pharmacy/pharmacies, the prescription will show in the system as filled when presented, thus preventing a prescription from being filled multiple times.

If a prescription is presented in the store but does not include all DEA, NPI and/or state license numbers, or other pertinent information, the pharmacy staff member may enter the medical practice or individual healthcare provider name into the system, e.g., into a search field present on the system. If the entered medical practice or healthcare provider is registered to the system, the name, medical practice info and preferably DEA, NPI and state license numbers will appear. If needed, this information can be used to contact the healthcare provider's office for validation of the prescription order.

Prescriptions may also include a unique identifier, such as a barcode, QR code, symbol, alpha numeric code, or any other suitable unique identifier. A prescription with a unique identifier may be searched and verified by a pharmacy staff member by inputting the unique identifier and retrieving the prescription information as written and uploaded by the healthcare provider, as an example the pharmacy may scan in a barcode present on a prescription presented at the pharmacy. Prescriptions may also be printed. In an embodiment the unique identifier may be pre-printed on a healthcare provider's prescription pad, or alternatively may be printed on a prescription generated using a prescription generating software or website. In the case of the prescription pads, the prescription pads have a unique identifier on each prescription page. An image of the prescription and/or the unique identifier of the prescription may be stored in the prescription verification system database. When the prescription is presented at the pharmacy, the pharmacy inputs the unique identifier into the prescription verification system. The prescription details (e.g., prescription image) and/or the unique identifier of the prescription on file in the prescription verification system database is shown to the pharmacy. The pharmacy can compare the information on the prescription verification system to the prescription presented at the pharmacy or electronically. After the pharmacy fills the prescription the pharmacy can mark the prescription as filled.

In another embodiment a prescription may be order electronically by a healthcare provider through an electronic prescription provider and transmitted electronically to the pharmacy with a unique identifier generated by the prescription verification system included with the electronic prescription. In such an embodiment the electronic prescription provider receives the electronic prescription order from the healthcare provider and accesses the prescription verification system to obtain a unique identifier to be associated with the prescription for verification purposes. The prescription verification system generates a unique identifier and provides the unique identifier with the ordered prescription. A receipt or claim check with the unique identifier is printed out, brought up via a patient's mobile device (such as a smart phone, tablet, pad, or the like), or otherwise made available to be presented at the pharmacy for verification, or is otherwise electronically associated with the prescription for verification by the pharmacy. In the case of mobile devices the patient, in one example, would register and login to the system, and access their prescription, which would be uploaded to their mobile device. In another embodiment the receipt, claim check, or prescription may also be retrieved via a link sent to their mobile device, such as via email, text, or the like. The patient would then present the prescription and/or receipt or claim check with the unique identifier at the pharmacy for verification and filling.

Once a prescription is filled the pharmacy can mark the prescription as filled, thus providing real time data to medical professionals and/or other pharmacies as to which prescriptions are filled or unfilled. This provides the ability for accurate real time reporting. When the prescription is filled and marked as such, the system can give a confirmation code to the pharmacy. The pharmacy can write down the confirmation code on the prescription. This will show that the prescription's authenticity has been verified, the pharmacy has used the prescription verification system before filling the prescription, and marked the prescription as filled. When the prescription is marked as filled it also will indicate so on the system should the prescription information be retrieved again. In the case where someone copies a prescription and takes it to the same or other pharmacy/pharmacies, the prescription will show filled when presented thus preventing a prescription from being filled multiple times.

A pharmacy may also enter the medical practice's business name into the system to retrieve a direct email link to communicate directly with a registered medical practice and/or access the medical practice's prescription data.

An advantage to the invention is that no more searches of multiple sites for DEA, NPI, state license numbers and office contact information is required, thereby reducing time consumed in filling the prescription. Direct phone contact with healthcare providers is only necessary when a discrepancy is detected, fraud suspected or information is not presented.

As may be appreciated by those of ordinary skill in the art, the system may be used for storage and retrieval of information. New functions and uses of the system can be further developed based on the description herein, and resulting from customer feedback and industry needs. Further functionality may include nonverbal communications between pharmacy and healthcare providers using, for example, email, texting, and/or other suitable technologies. The system may further provide for display of real-time data and images (e.g., scanned images of written prescriptions) for written prescription validation. Other uses may involve collection and display of attempted prescription fraud techniques circulating throughout the industry, as well as through access to reports of illegal drug diversion news from around the world, and links to pharmacy and to healthcare provider responsibility and liability information. The system and method may also be used for business management techniques. The design of graphics, functions and databases via software may take many forms so long as the basic functionality for the description of information collection and retrieval for the pharma-medical industry is maintained.

The system and method of the invention provides verification of medical prescription orders received by pharmacies verbally over the phone, via over-the-counter pick up using written or printed prescriptions, or via electronic prescription. In an embodiment the system provides an internet based validation service system, which is accessible to authorized users for entering and retrieving prescription information.

In terms of the specific working of the system, users of the system and methods are preferably licensed healthcare providers who are licensed, or otherwise authorized, to originate prescriptions, their authorized staff, and pharmacies and their staff members, as well as third-party electronic prescription providers. A third-party electronic prescription provider may include a company or system that submits/transmits, electronically, prescriptions, authorized by a healthcare provider(s) who originate prescriptions, to a pharmacy electronically and where such third-party electronic prescription provider operates separately from the system and method of the invention. In a preferred aspect, access and authorization to use the system and methods is done by registration of a business account. The system may include login pages stored on a server and accessible through the internet, or other suitable communications methods. On the other hand, database searches, member information, physician pharmacy data entry forms, and informational databases stored on the server may only be accessible to authorized users. Preferably, the server is a secure remote server and all communications with this secured remote server may be encrypted for security.

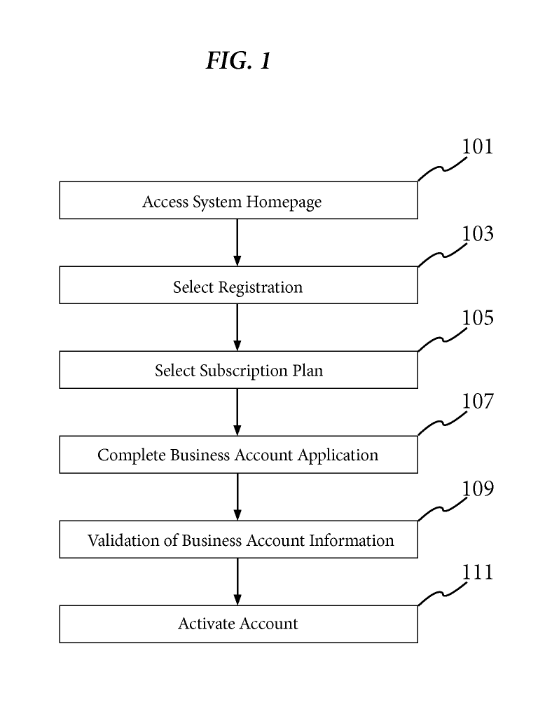

With reference to FIGS. 1-5 below, the system and method of the invention is described as embodied in a system including one or more servers with a web interface for hosting a website. However, it should be appreciated by one of skill in the art that the system and method of the invention may be carried out as a non web-based system including one or more database servers, preferably configured for managing information relating to medical personnel, electronic prescribing software, third party electronic prescribing software, pharmacies, and patients; and wherein the system can be accessed directly without requiring access through a website. In such an embodiment, instead of accessing and login into a prescription verification website, a user would access and login directly to the system's one or more database servers via a computer or other suitable device through a communications link. Such an embodiment is deemed to be within the scope of the present invention.

In the example below, the system may include a website with a set of interconnected webpages hosted on a central server web interface accessible via the internet, or other suitable communication methods, by use of its URL address or other suitable means. The system may be secured so only authorized users with proper identification can enter certain secured pages of the system and access features thereof. Healthcare providers who originate medical prescriptions can enter all pertinent information needed to confirm prescription orders and pharmacists can access that information to validate and verify all prescription orders. Additionally, third party electronic prescription providers and/or software may access the system to associate an electronic or software generated prescription with a unique identifier for prescription verification purposes.

Referring now to FIG. 1, there is shown a block diagram illustrating how a business account is established. Generally speaking, a licensed physician or pharmacist (“client” or “user”) may initiate an application to enroll their practice or pharmacy in the system through the system's access page, such as a homepage, which may be accessible at a specific URL, or other suitable means. This is done at Step 101 as illustrated in FIG. 1. In one example, a potential client accesses the system homepage using a unique URL address, and selects registration 103 to begin the business application process. The subscription plan desired is selected at 105, and if required a subscription fee paid, for example, through an entity such as PayPal® or any other suitable payment means. The business account application may then be completed 107. The system then validates the business account information 109 and transmits a notification to the client indicating that the account is activated 111.

In implementing the steps of FIG. 1 the client chooses the subscription plan that fits their practice or pharmacy needs. If there is a subscription fee, and an entity such as PayPal® is used as the payment website, payment for the service is made through the payment website's secure financial transaction system. When completing the business account application, the username(s) entered must be unique to the database. If not, the username(s) may be denied and a new username(s) requested. The validation step 109 may be conducted using on-line resources and/or direct contact with the applying businesses.

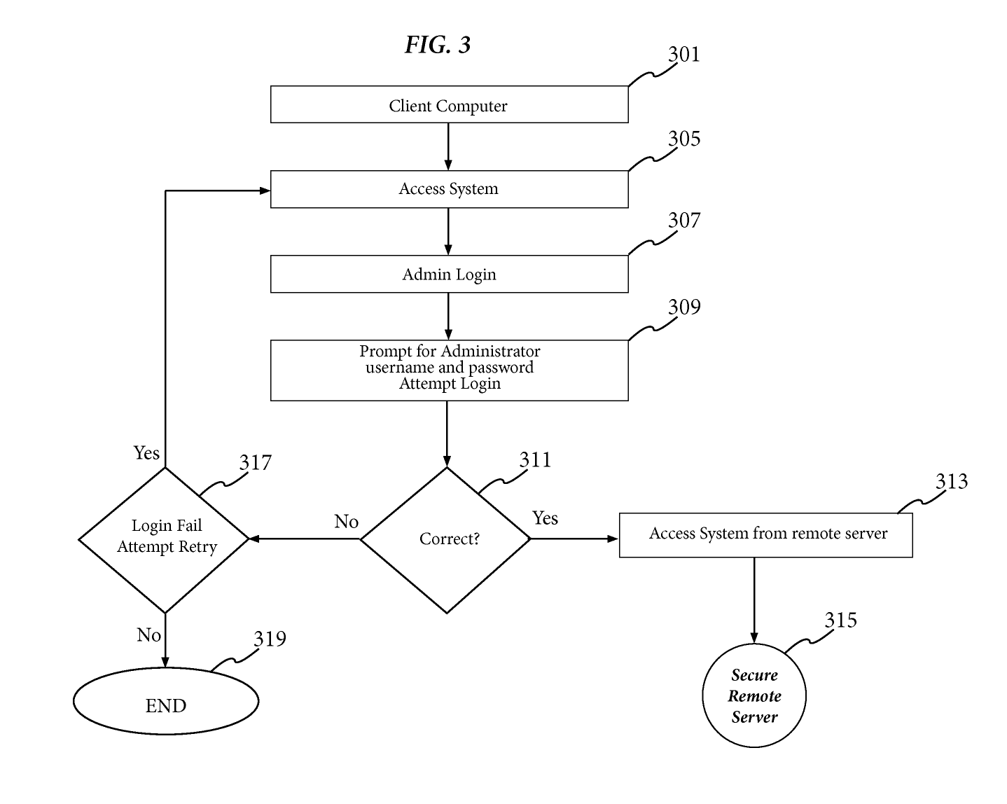

A notification 111 of a successful application may occur through email, text, verbally, or other suitable means, which is part of the information entered in the application. Thereafter, upon receipt of the validation notification, the business account will be activated with administrative secure access. The username and password for administrative access is preferably only used for managing the licensed physician or pharmacy business account as more clearly shown in FIG. 3. Access to features of the system, such as searching, may require separate usernames and passwords.

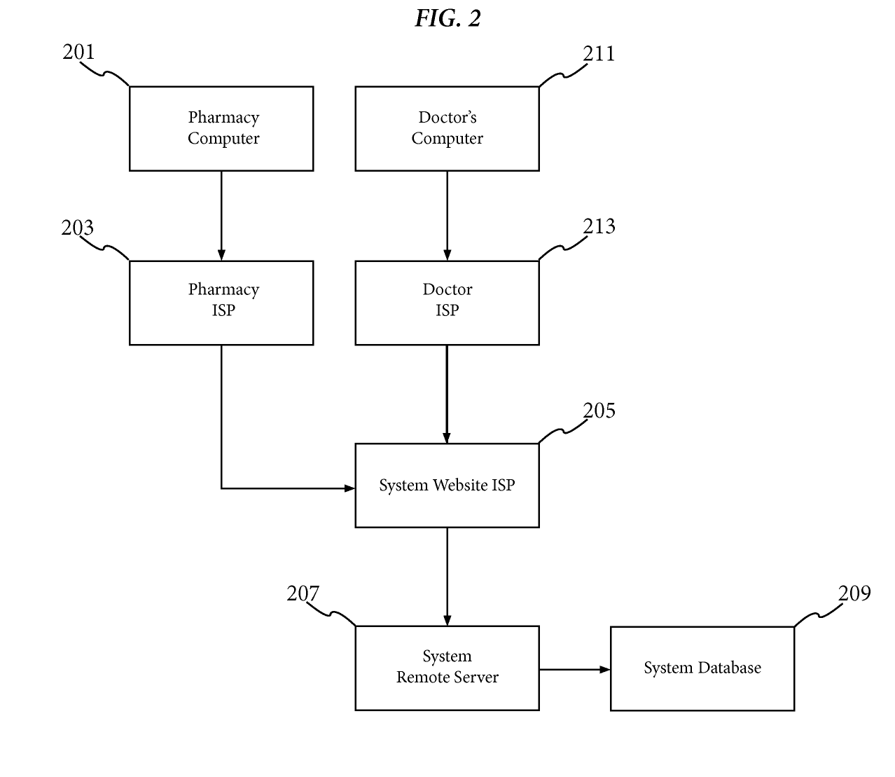

When the licensed physician or pharmacy has established a validated secure administrator login, the system may be accessed and the business account information managed. In addition, medical practice and pharmacy staff members may be registered. This is further illustrated in FIG. 2. In one example the client may access the system via the internet, or other suitable communication methods, through a computer, or other suitable device, at steps 201 or 211, respectively. The computer may be connected to their respective ISPs 203, 213 which then connect through the system's website ISP 205 to the system remote server 207, preferably through encrypted communications, accessing the server 207 then provides access, preferably through encrypted communications, to the system database(s) 209.

The information system is typically located on a server and may be a secure, central remote server accessed by contacting its numerical ISP address. The server computer(s) may be permanently connected to the internet and may be a centralized hub for other computers desiring access to the system.

As shown in FIG. 3, access to the system server is preferably available to clients having a secure, encrypted administrative level username and password established in the initial account application as established in FIG. 1. The client, using a computer 301, or other suitable device, accesses the system via the internet, or other suitable communications method/link. A connection is established to the system 305 and shows the system homepage (e.g., website homepage), with an administrative login 307. Selecting the administrator login, the client accesses the business administration login page 309, which has the username and password setup with the initial business account application for registration. If the information entered is correct 311, then access to the system from the remote server is provided 313 and the client can access the secure remote server 315. If the information entered is incorrect in step 311, the login fails 317 and an attempt to login can again be initiated at step 305. Alternatively, if the login fails without a retry, the process ends at step 319.

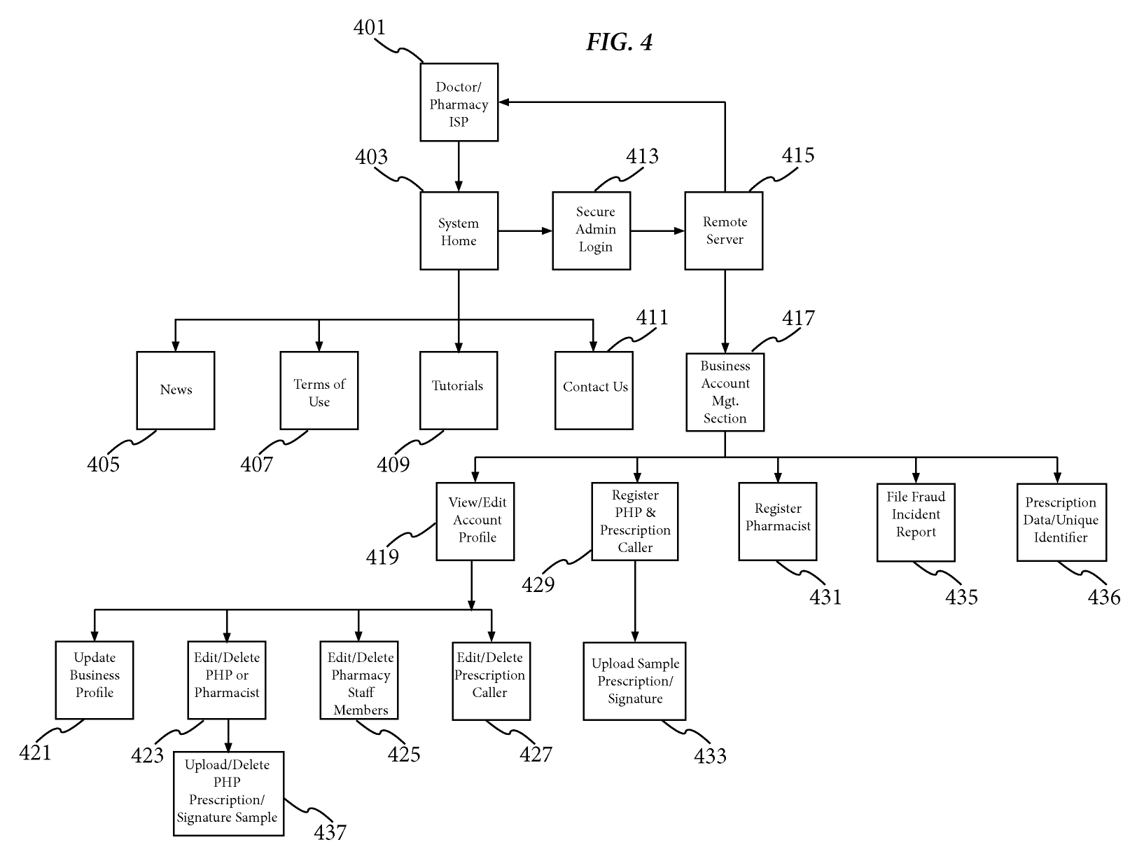

Once the administrative account is set up, physicians, their staff, pharmacies and optionally pharmacy staff users, and third party electronic prescription providers may be registered at the system, as illustrated in FIG. 4. Access is through, for example, the doctor or pharmacy ISP 401 which connects to the system home screen (e.g., homepage) 403. The users may be allowed access to a news section 405, terms of use 407, tutorials 409, and/or a contact us section 411 of the system. Alternatively, the client administrator can login at a secure login 413 which connects to a server 415 and directs the administrator to the business account management section 417. At that section, a number of additional options may be presented, for example, viewing or editing the account profile 419; registering primary healthcare providers and physician staff users 429; registering pharmacists and optionally pharmacy staff users 431; registering third party electronic prescription providers (not shown); if a fraudulent transaction is suspected, reporting a fraud incident report through a fraud section at 435; and/or enter the prescription data information and unique identifier section 436.

If the account profile is viewed or edited 419, various options may also be presented, for example, updating the business profile 421, editing or deleting a primary healthcare provider or pharmacist 423, optionally editing or deleting a pharmacy staff member 425, editing or deleting a prescription caller 427, or editing or deleting a third party electronic prescription providers (not shown). If registering of the primary healthcare provider and prescription caller is selected at step 429, then at step 433 an upload sample prescription and/or healthcare provider signature may be provided to allow comparison and verification of a written prescription by a pharmacy staff member when presented with a written or printed prescription.

By way of further clarification, view/edit account profile section 419 serves to display and manage the business account. View/edit account profile section 419 may direct the client to a business account profile data results section that lists information specific to their business account and allows them to manage the information. Such information may include name, address, phone/fax numbers, email address and/or URL of the account. Updates may be saved by submitting updates to the system and saving, revised information is saved and the system returns to the business account profile page to check for the accuracy of the updates.

At 429, the primary healthcare provider and staff users may be registered. This takes the client to an add primary healthcare provider or staff users section and, in one example, may include a two tabbed form, for example, one for adding a primary healthcare provider and one for adding primary healthcare provider staff. The client then selects the desired page, e.g., selects the tab for primary healthcare provider or primary healthcare provider staff. If prescription originators (e.g., healthcare providers) or prescription order callers are to be registered or updated, at 429 the user client is prompted to enter all information requested in the required fields to register primary healthcare provider staff who are authorized to call in medical prescription orders. The system will generate a unique identification code for each individual prescription caller registered and may be listed on the business account profile page accessible only by the administrator. A notification, such as an email or other suitable means, is then sent to the registered prescription caller to inform them of their assigned identification code, to use when calling in prescription orders.

For a new primary healthcare provider, all information is typically entered in the required fields to register personnel who are authorized to originate prescription orders. The personnel who are authorized to originate prescription orders are preferably listed on the business account profile page and the search results section as a result of a search inquiry. The number of staff which may be entered is preferably sufficient to accommodate small to very large practices. Inaccuracies may be edited by selecting the identification code of the affected profile, and editing as may be required.

At 431, the pharmacist and optionally other pharmacy staff members (e.g., pharmacy technicians) may be registered. This will typically take the client to an add pharmacist section and may include a two tabbed form, for example, one for adding pharmacist and one for adding other pharmacy staff members. The client then selects the desired registration form. For new pharmacists, all information is typically entered in the respective system fields to register new pharmacists. A similar process is followed for new pharmacy staff members to be added.

There is also provided a section 435 for reporting fraud incidents. This section is used to report fraud schemes and attempts experienced by the physician office or pharmacy.

As previously discussed, there is provided a section 433 for healthcare providers to upload a sample written prescription and/or authorized signatures for allowing comparison to printed or written prescriptions presented to the pharmacy, for example, at an in-store counter or drive-through window. The healthcare provider may scan a copy of a voided sample prescription complete with the healthcare provider's signature in JPG, or other suitable format. The healthcare provider may then navigate to the signature verification setup page and upload the scanned in voided sample prescription with the healthcare provider's signature to be used for verification purposes. The image of the uploaded sample prescription is then available to the pharmacy for verification purposes. A pharmacy may access the uploaded sample prescription via the system's searching function. When the search results are received, the pharmacy selects the particular healthcare provider's identification code for an image of the sample prescription and/or signature for comparison to verify a presented prescription.

There is also provided section 436 for healthcare providers to upload a prescription associated with a specific prescription unique identifier, such as barcode or other suitable identifier, this section takes the healthcare provider to a prescription data section. The prescription is written by the healthcare provider either by hand or printed through a computer system and printer. The healthcare provider navigates to the prescription section 436, enters the unique identifier specific to the written/printed prescription into the database and uploads a scanned image, or enters the prescription details of the specific prescription under that specific unique identifier. The information is then available for access by a pharmacy to verify the details of a written or printed prescription presented at the pharmacy.

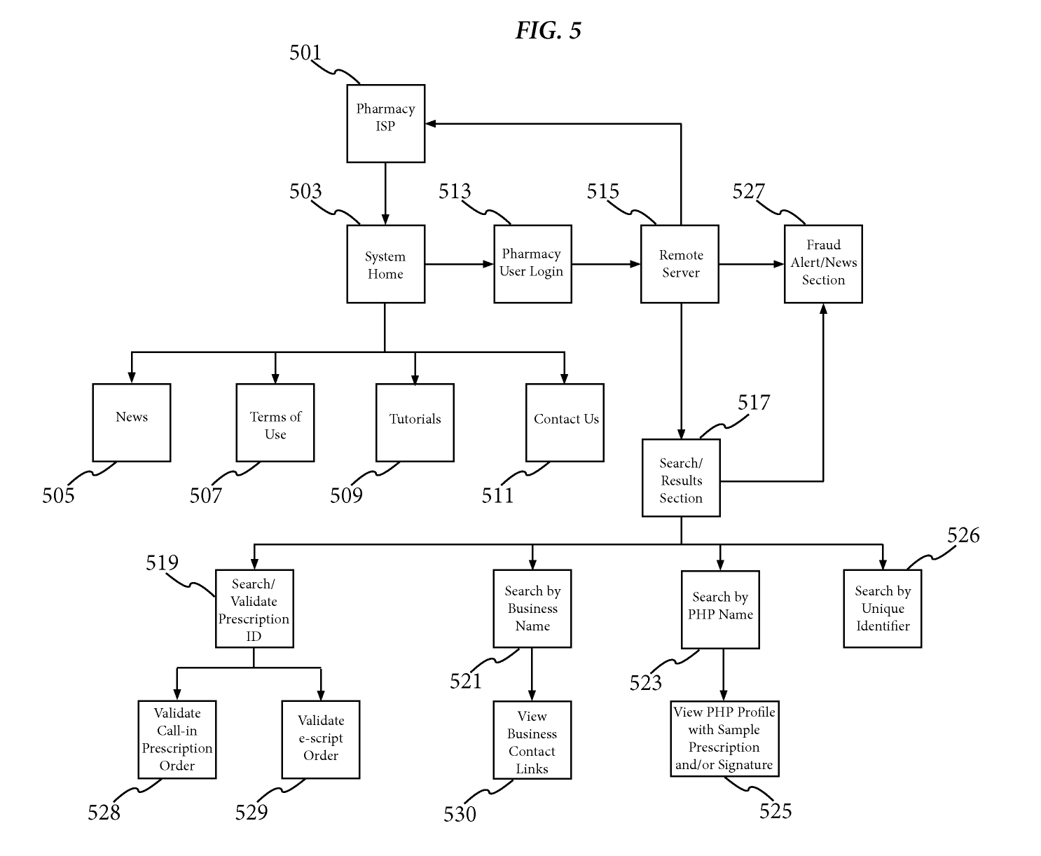

Turning now to FIG. 5, there is illustrated an example how a pharmacy staff member may access and use the system. The pharmacy staff member, using their computer, or other suitable device, accesses the system via the internet, or other suitable communication link/methods, for example, the pharmacy staff member may access the system through the pharmacy ISP 501 to arrive at the system home (e.g., homepage) 503. From that homepage 503, a number of other sections may be accessed such as a news section 505, terms of use 507, tutorials 509 or a contact section 511. Alternatively, the pharmacy staff member may directly login 513 for access to server 515 for conducting a search and obtaining results section 517. Access to remote server 515 is preferably encrypted. The searches can include searching and validating the prescription caller identification code 519 including validating a call-in prescription order 528, an electronic prescription order 529, or a printed or written prescription, searching by business name 521 to view business contact links 530 (e.g., to contact a healthcare provider by email or other means), searching by primary healthcare provider name 523, which then may further include viewing a sample prescription and/or signature 525, or searching by unique identifier 526. A pharmacy staff member can also navigate from the search section 517 or directly through access from the remote server 515 to a fraud alert and news section 527 which may contain links to articles, government documents and ongoing court cases and recent decisions, as well as other fraud related incident scheme reports from, for example, colleagues around the industry which may be posted.

Discussing FIG. 5 in greater detail, a number of different options are presented in the remote server, which may be a secure remote server. In the search/validate section 519, the client user may enter the prescription caller identification code provided in the phoned-in, printed, written, or electronic prescription order and search to facilitate validating call-in prescription 528, electronic prescription 529, or printed or written prescriptions. If the entered identification code corresponds to a valid registered prescription caller, the prescription caller identification code and/or associated information will appear as well as, for example, the name, address, phone number and email address of the associated practice with this prescription caller. All of the primary healthcare providers at this practice may be listed with their DEA, NPI and license numbers, and other contact information. The pharmacy staff member then compares and validates that all the information returned in the search matches information stated in the prescription or by the prescription caller when the prescription order was placed. If the identification code search is not a valid registered prescription caller, the results section will be blank and this indicates that a possible fraud scheme may have been attempted. The prescription request should be held until the pharmacy can contact the healthcare provider office to verify legitimacy. If the healthcare provider cannot verify the order as legitimate or a mistake was made, the pharmacy may inform the healthcare provider of a fraud attempt in the prescription order.

With respect to searching by business name 521, particular medical practices may be searched on the system when no prescription caller identification code is given in a prescription order. These search results are preferably limited to valid registered medical practices. The user may enter the medical practice name in the system and conduct a search. If the practice name entered is a valid registered member, information about the member will appear, e.g., view business contact links 530, and the user can contact the healthcare provider if listed to verify prescription orders or to report a fraud attempt. If the name of the healthcare provider is not a valid member, the results page is shown as blank and this indicates that a possible fraud scheme has been attempted.

A search may also be conducted by a primary healthcare provider's name at 523. This search may be used, for example, by a pharmacy staff member to search for registered primary healthcare providers when a prescription is presented at the pharmacy, e.g., in-store or at drive-thru window. The name may be entered as shown on the prescription and a search conducted. If it is a valid healthcare provider member, the name, primary healthcare provider (PHP) profile, DEA, NPI and/or license numbers and other contact information may appear. At 525, PHP profile and/or a written prescription and/or signature sample can be viewed. Alternatively, if the name search is not a valid member, a fraud report can be made. It should be noted that this is but one example, and a pharmacy may be able to pull up and view a prescription image, prescription sample and/or signature sample of an ordered prescription/healthcare provider via other search functions of the system, e.g., by prescription caller identification code, business name, healthcare provider name, and/or prescription unique identifier

A search may also be conducted by a prescription unique identifier at 526. This search may be used, for example, by a pharmacy staff member to access prescription data via a prescription unique identifier when a prescription is presented, and allows a pharmacy staff member to mark a specific unique identifier prescription as filled. This search may also be used, for example, by a pharmacy staff member to verify an electronic prescription generated by a third party electronic prescription provider. The pharmacy staff member enters the unique identifier from the prescription and a search is conducted. If a valid unique identifier, the exact prescription, or prescription details, as input by the healthcare provider, will appear, and may further include the medical practice/healthcare provider's information as well, for the pharmacy staff member to view and compare to the prescription presented. If the prescription is valid, the pharmacist will fill the order and update the prescription status to “filled”. If the prescription is not valid, e.g., copied and filled at a different location, the prescription status will reveal the prescription was previously filled and indicate a fraud alert. Further, if the prescription unique identifier has been altered, it will be alerted as invalid and indicate a fraud alert.

The system may also be used by a third party electronic prescription provider or third party prescription software, by the system providing unique identifiers that will verify and/or track prescriptions. These prescriptions are generated by the third party and the prescription verification system of the present invention generates a unique identifier to be associated with the electronic prescription. In one example, the third party software is in communication with the prescription verification system of the present invention. When the healthcare provider submits the prescription order via the third party software, the third party software reaches out and accesses the prescription verification system and a unique identifier is assigned by the prescription verification system that is specific to that prescription. When the prescription is printed or downloaded, e.g., by the healthcare provider, pharmacy, or patient, it has the unique identifier, generated by the prescription verification system, printed on, or otherwise associated with it, which the pharmacist can enter to verify the prescription is valid. In another example, the prescription may be transmitted electronically directly to the pharmacy and a unique identifier included in the prescription file. In this example, a prescription may be submitted electronically by a healthcare provider through, for example, an electronic prescription provider and transmitted electronically to a pharmacy with a unique identifier specific to the prescription generated by the prescription verification system included with the prescription. In such an embodiment, the electronic prescription provider receives the electronic prescription order from the healthcare provider and reaches out and accesses the prescription verification system to obtain a unique identifier to associate with the prescription for verification purposes. The prescription verification system of the invention generates a unique identifier and associates it with the electronically ordered prescription. A receipt or claim check with the unique identifier may be printed out by the healthcare provider, for example, or brought up via a patient's mobile device (such as a smart phone, tablet, pad, or the like) to be presented at the pharmacy, or accessed directly from the server or via website by the pharmacy for verification. In the case of mobile devices the patient, in one example, would register and login to the system, and access their prescription on their mobile device. The patient would then present the uploaded prescription and/or receipt or claim check with the unique identifier at the pharmacy for verification and filling.

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicant's invention set forth in this specification, and neither its use nor its absence is intended to limit the scope of the applicant's invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation, as the present invention is defined by the claims as set forth hereinafter.

What is claimed is:

1. A prescription verification system comprising:
(a) one or more servers configured for managing information related to medical personnel, pharmacies and patients, wherein the one or more servers, comprise;
(i) a first portion configured for creating and allowing access to created individual medical personnel files;
(ii) a second portion configured for creating and allowing access to created individual pharmacy files;
(iii) a third portion configured for creating and allowing access to created individual patient information; and
(b) the one or more servers further configured for assigning unique identification codes for authorized users of the system.

2. The system of claim 1, wherein the system comprises a web based system and wherein the one or more servers comprise a web interface for hosting a website.

3. The system of claim 1, wherein the one or more servers comprise database servers.

4. The system of claim 1, wherein the patient information comprises prescription data.

5. The system of claim 1, further comprising an encryption function to gain access thereto and further programmed for requiring users desiring to access the system to have an authorized code.

6. The system of claim 5, wherein users comprise individuals, electronic prescription providers, and/or prescription software.

7. The system of claim 2, wherein the system is accessible via the internet.

8. The system of claim 1, wherein the system is accessible via a computer.

9. The system of claim 1, wherein the system is accessible via a mobile device.

10. The system of claim 9, wherein a patient's prescription data is uploadable to a patient's mobile device.

11. The system of claim 10, wherein the patient's prescription data is viewed by the pharmacy on the patient's mobile device.

12. The system of claim 1, wherein the unique identification codes for authorized users can be edited by such authorized users.

13. The system of claim 1, further configured for storing a user profile.

14. The system of claim 13, wherein the user profile is for a medical practice and can include license information.

15. The system of claim 14, further comprising a list of authorized medical practice individuals stored on the system who are authorized to provide a prescription, wherein each medical practice authorized individual is provided with a unique identification code.

16. The system of claim 13, wherein the user profile comprises pharmacy information.

17. The system of claim 13, wherein the user profile comprises electronic prescription provider information.

18. The system of claim 4, wherein prescription data is accessed by inputting a unique identifier into the system associated with a specific prescription.

19. The system of claim 18, wherein inputting a unique identifier comprises scanning a barcode.

20. The system of claim 1, wherein the prescription is generated from one or more of the following a third party electronic prescription provider, prescription software, hospital, physician, medical practice, homecare service provider, nursing service provider, website, or any other entity or individual legally authorized to issue a prescription.

21. The system of claim 1, further comprising a portion configured for generating electronic prescriptions.

22. The system of claim 1, further configured for verifying prescriptions generated from a third party electronic prescription provider or software.

23. The system of claim 22, wherein each prescription generated from the third party electronic prescription provider or software is assigned a unique identifier.

24. The system of claim 1, wherein a unique identifier is generated and assigned to each prescription entered or uploaded into the system.

25. The system of claim 1, wherein the system is further configured to verify prescriptions prescribed in written, verbal, printed, and/or electronic form.

26. The system of claim 1, wherein the system is further configured for tracking filled and/or unfilled prescriptions.

27. The system of claim 4, wherein the prescription data comprises an image of the prescription as prescribed.

28. The system of claim 26, wherein for a prescription marked as filled a confirmation number is generated.

29. The system of claim 1, wherein a prescription is verified using one or more of the following methods verbally, printed prescription pad, printed via prescription software, and/or electronic prescribing.

30. The system of claim 29, wherein verbal prescription verification comprises a medical practice authorized individual stating their unique identification code and a pharmacy staff member entering the unique identification code into the system for verification of the prescription.

31. The system of claim 29, wherein prescription verification via printed prescription pad, printed via prescription software, and/or electronic prescribing comprises a pharmacy staff member entering a unique identifier associated with the prescription into the system for verification of the prescription.

32. A computer implemented method of verifying prescription information, the method comprising:
(a) providing a system configured for managing information relating to medical personnel, pharmacies and patients;
(b) registering medical practices and medical practice staff authorized to order prescriptions at the system, and assigning a unique identification code for each medical staff member;
(c) registering pharmacies at the system; and
(d) verifying prescriptions by allowing ordered prescriptions by authorized medical staff members and verification by a pharmacy staff member, wherein the authorized medical staff members present their identification code to the pharmacy staff member to verify authorization through access to the system, or the pharmacy staff member entering a unique identifier associated with the prescription into the system to verify authorization through access to the system.

33. The method of claim 32, further comprising accessing the system through a computer.

34. The method of claim 33, wherein the computer accesses the system via the internet.

35. The method of claim 32, wherein the system is capable of being accessed by a mobile device.

36. The method of claim 35, wherein the mobile device accesses the system via the internet.

37. The method of claim 32, wherein the system comprises a web based system and wherein the one or more servers comprise a web interface for hosting a website.

38. The method of claim 32, wherein the system comprises one or more database servers.

39. The method of claim 37, wherein the website comprises an interactive secure website.

40. The method of claim 32, wherein the system is further configured for managing information relating to third party electronic prescription providers or software.

41. The method of claim 32, further comprising allowing access to the system through encrypted communications.

42. The method of claim 32, wherein the system is further configured for storing user profiles at the system for authorized users.

43. The method of claim 32, wherein the system is further configured for storing prescription data.

44. The method of claim 43, wherein the prescription data comprises an image of the prescription as prescribed.

45. The method of claim 43, wherein stored prescription data is accessed by entering a unique identifier associated with a specific prescription into the system.

46. The method of claim 32, further comprising allowing authorized users to access prescription data input by the registered medical practice.

47. The method of claim 32, wherein the prescriptions are generated from one or more of the following a third party electronic prescription provider, prescription software, hospital, physician, medical practice, homecare service provider, nursing service provider, website, or any other entity or individual legally authorized to issue a prescription.

48. The method of claim 32, wherein the system is further configured for generating electronic prescriptions.

49. The method of claim 32, further comprising verifying prescriptions generated from a third party electronic prescription provider or software.

50. The method of claim 32, wherein the system is further configured for generating a unique identifier for each prescription.

51. The method of claim 32, further comprising verifying prescriptions prescribed in written, verbal, printed, and/or electronic form.

52. The method of claim 32, wherein the system is further configured for tracking filled and/or unfilled prescriptions.

53. The method of claim 52, wherein for a prescription marked as filled a confirmation number is generated and associated with the filled prescription.

54. The method of claim 32, wherein a prescription is verified via one or more of the following methods verbally, printed prescription pad, printed via prescription software, and/or electronic prescribing.

55. The method of claim 54, wherein verbal prescription verification comprises a medical practice authorized individual stating their unique identification code and a pharmacy staff member entering the unique identification code into the system for verification of the prescription.

56. The method of claim 54, wherein prescription verification via printed prescription pad, printed via prescription software, and/or electronic prescribing comprises a pharmacy staff member enter a unique identifier associated with the prescription into the system for verification of the prescription.

57. A centralized system for verifying medical prescriptions through the internet, the system comprising:
(a) an interactive secure website hosted on a server which is accessible via the internet through one or more computers, for storing and retrieving medical provider information for use in verification of prescription orders;
(b) the website configured for allowing access through secure communications by authorized pharmacy, authorized medical personnel, and authorized third parties; and
(c) the website being further configured for creating business accounts for pharmacies and medical personnel, and configured for editing the accounts by authorized personnel.

58. The system of claim 57, wherein the authorized third parties comprise electronic prescription providers and/or prescription software.

59. The system of claim 57, wherein the website comprises an image store for storing images of prescriptions and/or signatures for validating prescriptions at a pharmacy.

60. A prescription verification system comprising:
(a) a secure website configured for managing information related to medical personnel, pharmacies and patients;
(b) a first portion of the secure website for creating and allowing access to created individual medical personnel files;
(c) a second portion of the secure website for creating and allowing access to created individual pharmacy files;
(d) a third portion of the secure website for creating and allowing access to created individual patient prescription data; and
(e) the website further configured for assigning and displaying unique codes for authorized users of the secure website.

61. A computer implemented method of verifying prescription information, the method comprising:
(a) providing an interactive secure website configured for managing information relating to medical personnel, pharmacies and patients;
(b) registering at the website medical practices and all medical practice staff authorized to order prescriptions, and assigning a unique medical staff identification code for each medical staff member;
(c) registering at the website pharmacies; and
(d) verifying prescriptions by only allowing ordered prescriptions by authorized medical staff members and verification by a pharmacy staff member, wherein the authorized medical staff members present their identification code to verify authorization through access to the system, or the pharmacy staff member enters a unique identifier associated with the prescription into the system to verify authorization through access to the system.
